(19) United States
(12) Patent Application Publication
(10) Pub. No.: US 2024/0294773 A1
(43) Pub. Date: Sep. 5, 2024

(54) COATING COMPOSITION AND PROCESS FOR APPLYING SAME TO METAL SUBSTRATES

(71) Applicant: CIA. INDUSTRIAL H. CARLOS SCHNEIDER, Joinville - SC (BR)

(72) Inventor: Marcelo Da Silva GOMES, Joinville (BR)

(21) Appl. No.: 18/571,844

(22) PCT Filed: Jun. 21, 2022
(86) PCT No.: PCT/BR2022/050227

§ 371 Date: Dec. 19, 2023

(30) Foreign Application Priority Data
Jun. 21, 2021 (BR) 1020210122528
Jun. 13, 2022 (BR) 1020220116474

(51) Int. Cl. C09D 5/10; B05D 7/14; C09D 5/08

(52) U.S. Cl. CPC C09D 5/103; B05D 7/14; C09D 5/086; C09D 5/106

(57) ABSTRACT

Coating composition and respective process for applying same to metal substrates. The present invention pertains to the field of coatings, more specifically to an anti-corrosion coating composition comprised of at least three layers to provide protection against galvanic corrosion. The coating (5) is configured by at least three distinct layers (2, 3, 4) applied to the same metallic component. The base layer (2) consists of an organometallic dispersion containing zinc and aluminum alloys or a zinc or zinc alloy base applied electrolytically to the metal surface (1). An aqueous intermediate layer (3) is applied over the base layer (2) containing silicon oxide nanoparticles of up to 50 nanometers. An outer layer (4) rich in aluminum dispersed in organic solvents or water and binding elements is also affixed to intermediate layer (3). The present invention further discloses a process for applying the coating (5) and the use thereof in fastening elements that are in direct contact with aluminum components that are much larger than said fastening elements, in order to prevent galvanic corrosion.

The present invention belongs to the field of coating compositions, more specifically, it refers to a multilayer anti-corrosion coating composition comprising at least three layers, wherein the intermediate layer is comprised of an aqueous composition containing silicon oxide nanoparticles of up to 50 nanometers and the outer layer is rich in aluminum. Additionally, the present invention discloses a process for applying said coating to metal substrates to enhance corrosion resistance and minimize the effect of galvanic corrosion of the components when in direct contact with aluminum components.

### HISTORY OF THE INVENTION

Galvanic corrosion is the electrochemical process when two metals are placed in contact and initiate a corrosion process caused by the transfer of electrons in the presence of an electrolyte. Dissimilar metals and metal alloys have different electrode potentials. Thus, when two or more metals come into contact at an electrolyte, one of the metals acts as an anode and the other as a cathode. The electro potential difference between the dissimilar metals is the driving force for an accelerated attack on the anodic member of this galvanic pair.

Currently, the most used material in coatings for aluminum fasteners is stainless steel. However, depending on the area of the component to be fastened, stainless steel can cause galvanic corrosion on the aluminum component.

When placing in contact two metals with different potentials in a conductive medium, such as sea water or condensation, there can occur a reaction commonly known as galvanic cell. The greater the difference in electric potential between the metals, the greater the possibility of a reaction occurring.

In the case of zinc and aluminum, there is only a small chance of the occurrence of a reaction, due to the relatively small difference in potential between the two metals (−1.10 for zinc and −0.86 for aluminum), apart from forming an insulating film on the aluminum surface.

The electrode potential of carbon steel and cast iron is of −0.68 and of stainless steel 18% CR 8% Ni (active) is of −0.61.

Thus, due to the differences in electrode potential, a severe reaction can occur when a large cathode (greater or more positive potential) is in contact with a small anode (lesser or negative potential). In this situation, the corrosion rates can increase significantly.

Another material widely used as a coating for fasteners made in aluminum is carbon steel coated with electrolytic steel, zinc alloys and organometallics (zinc flakes). However, the resistance to galvanic corrosion of the electrolytic zinc is very low. Now, the corrosion resistance of the zinc alloy is medium, however, it has a high cost (iron zinc or nickel zinc). Additionally, organometallic coatings have great restrictions due to the fragility of the protective layer.

Despite the organometallics having aluminum in the composition thereof, which reduces the galvanic corrosion effects, when fasteners comprised of said coatings are installed in the place of interest, the coating layer many times ends by being removed due to the friction, which exposes the base metal to the weather agents, initiating the corrosion process.

Further, installations which are exposed to external conditions, such as, for example, solar panels, bring a need which is still not sufficiently solved by the state of the art, considering the cost-benefit ratio, that is, the durability of the fastening associated with the economic aspects, since in these cases it is necessary to have an efficient and longer lasting fastening means, without corrosive processes (including galvanic corrosion).

Thus, among the many applications, the present invention solves, for example, the fastening of aluminum structures for photovoltaic panels, whereby said fastening is carried out by means of carbon steel screws coated with organometallic material.

Thus, the present invention contributes in an important manner to the durability and safety of the fastening structures for solar panels, for example. Thus, the present invention is an ally in the diversification of the energetic matrix and, consequently, in the minimization of the emission of greenhouse gases. In short, the present invention renders the investment in solar energy more attractive in the long run, due to the lower maintenance cost of the system, apart from the safety provided by the fastening means which do not oxidize or oxidize very slowly with the exposure of the aluminum structures to the weather.

Aiming at a technical solution and with accessible cost, this invention intends applying a highly efficient coating system against galvanic corrosion, with the purpose of providing the market with an alternative solution to stainless steel and with greater efficiency than the conventional coatings, such as electrolytic zinc and zinc alloys, as well as a protective coating with greater hardness than the traditional organometallic coatings.

The present invention in an advantageous manner is comprised of an intermediate coating layer comprising silicon oxide nanoparticles of up to 50 nanometers dispersed in water, binding elements, alcohols and ethers, which provide a strong adherence based on electrolytic zinc or organometallic, sealing the surface so as to avoid the action of the weather, increasing corrosion resistance up to 20 times relative to the conventional electrolytic coatings and up to 3 times relative to the conventional organometallic coatings.

### STATE OF THE ART

In the state of the art there exist several manners of reducing and preventing galvanic corrosion, one of which is to electrically insulate the two metals which are in contact. If there is no electric contact, the galvanic pair will not occur. This can be achieved using non-conductive materials placed between metals comprising distinct standard electrical potentials. Another way is to use the same material in the structure and in the fasteners, there is no formation of the galvanic cell.

Another way of solving and making the electrical insulation between the fasteners and the aluminum structure is by means of the use of insulating washer screws (EPDM) as can be observed in FIG. 1. In this case, the washers protect the contact of the fastener flange with the aluminum structure, however, the body of the screw remains unprotected, maintaining direct contact with the structure.

As shown in FIG. 2, another state of the art solution is the use of insulating covers. The main disadvantage of this solution is the increase in assembly time of the structure, which can impair the tightening of the fasteners, maintaining the structure fragile and pre-disposed to maintenance.

Another solution of the state of the art are aluminum screws of the same material as the fastening component and, thus, without galvanic corrosion. These screws are manufactured from aluminum alloys with resistance equivalent to that of the steels, however, said screws are known to strip the thread, perhaps due to the fact that many screws are manufactured with an unsuitable selection of aluminum alloy to be used for the manufacture thereof.

In this way, unequivocally, steel screws are the most popular, since they reconcile cost and resistance advantages, despite the steel ones being lighter and more resistant to oxidation. Further, regarding the aspect of resistance to corrosion, there exist in the state of the art stainless steel screws which are less susceptible to corrosion than the aluminum alloys. However, at a higher cost.

In summary, several types of screws are manufactured and used, as well as screws from copper, molybdenum, tungsten alloys and even screws with non-metallic materials. Said screws are usually submitted to torque and axial load, resulting in normal axial and shear stress.

Technically, it is possible to produce fasteners with aluminum and other materials with high resistance, however, the high cost and extremely low availability in the market do not make these state of the art options attractive from the economical point of view.

As regards the use of coatings, patent document JPH0853774 refers to an invention which provides corrosion resistance and weather resistance, by forming a mineral boehmite coating (AhOs·nFW) on the surface of the aluminum or alloy base material and more than one multilayer coating, further containing a ceramic layer comprised of metallic ion oxide.

The manufacturing process disclosed in said Japanese document consists of the following steps: after the boehmite coating film is formed on the surface of the AL alloy base material, the oxide ceramic layer, in which the metal oxide is dispersed, is laminated thereon. In this case, the ceramic oxide layer 3 contains, preferably, one of the metal oxides selected from a group consisting of silicon oxide, aluminum oxide, zirconium oxide, titanium oxide and magnesium oxide and the metallic ion oxide, containing, preferably, at least one type selected from the group of chrome ion, yttrium ion, zirconium ion and magnesium ion. The metallic ion oxide is dispersed in ceramic by dipping the formed ceramic layer into a metallic ion aqueous solution, following the drying and firing steps.

Document WO2008010533 discloses a metal oxide nanoparticle exhibiting high dispersibility in various solvents, monomers, or polymers, which is capable of imparting a resin composition or the like with various characteristics. Specifically disclosed is a metal oxide nanoparticle coated with two or more coating agents, which is characterized in that at least one of the coating agents is represented by the following formula (I). R1-COOH (I). In the formula, R1 represents a hydrocarbon group having 6 or more carbon atoms. This state of the art document does not disclose a coating for maintaining the use of zinc as coating base against corrosion, also adding a nanotechnology sealing layer to enhance the resistance to corrosion and a coating layer that is rich in aluminum to lessen the effect of galvanic corrosion in steel, iron or other metallic alloy components, when these components are placed in contact with aluminum components.

Document BRPI0617069 discloses coating compositions comprising corrosion resistant particles. More specifically, the document discloses primer and/or pretreatment coating compositions, such as caustic primers, comprising: (a) an adhesion promoting component; and (b) corrosion resistant particles selected among: (i) magnesium oxide particles having a mean primary particle size not greater than 100 nanometers; (ii) particles comprising an inorganic oxide crosslink comprising one or more inorganic oxides; and/or (iii) chemically modified particles having a mean primary particle size of not more than 500 nanometers. The present invention, advantageously, is comprised of a nanoceramic sealant, which comprises an aqueous composition containing silicon oxide nanoparticles of up to 50 nanometers.

Another example of coating from the state of the art is patent document WO2006110756A1, entitled “corrosion resistant article and method of production thereof”, filed on Apr. 11, 2005, referring to an article comprising electrolytic zinc or zinc alloys or firing zinc coating with the application of a silicate-based sealant. However, said document has the sole purpose of improving resistance to corrosion for screws and nuts for the automobile market and increasing conductivity through an aluminum oxide layer over the substrate. However, disadvantageously, the document does not disclose characteristics which resist galvanic corrosion in coated steel screws for assembly in aluminum component counterparts.

Another example is patent document GB1471977A, entitled “organic coating of metallic substrates”, filed on Sep. 28, 1973, which refers to a vacuum vapor zinc-based coating and to the application of a radiation polymerized primer and passed through vacuum in metallic rollers. However, the document does not disclose a coating capable of solving existing problems of galvanic corrosion between zinc and aluminum nor does it present application to fasteners.

### SUMMARY OF THE INVENTION

The present invention discloses a multilayer coating, which is configured by at least three distinct types of layers applied to the same metallic component, whereby a first base layer is placed in contact with the metallic component surface, configured by an organometallic dispersion based on zinc and aluminum alloys, whereby this can have an aqueous base or organic solvent base, or a zinc base or zinc alloys applied electrolytically to the metallic surface.

Thus, the base layer, configured by organometallic dispersion based on organic solvent, comprises the following compositions in percentage by weight:
from 20 to 60% zinc;
from 1 to 5% aluminum
from 10 to 20%2-Ethylhexanol;
from 5 to 10% heavy hydrogen desulfurized naphta (mineral oil);
from 0 to 3% n-butyl alcohol 71-36-3 1;
from 1 to 3% naphta solvent, petroleum, light aromatic;
from 1 to 3% stearic acid;
from 0 to 0.2% ethylbenzene;
from 0 to 0.2% standard solvent.

The base layer, configured by the aqueous based organometallic dispersion, is configured by the mixture of a compound A, a compound B and a compound C which comprise the following compositions in percentages by weight:

### Compound A

from 20 to 40% zinc;
from 2 to 10% aluminum;
20 to 30% dipropylene glycol;
1 to 2.5% non-ionic surfactant;
15 to 20% deionized water.

### Compound B

Silane (A-187);
70 to 90% deionized water;
0.1 to 0.2% boric acid;
2 to 3% sodium silicate;

### Compound C

0.2 to 2% hydroxiethylcellulose per Kg of the mixture of compounds A+B

When the base layer is zinc or zinc alloys, the thickness of the base layer is of 5 to 25 micrometers, whereby up to 12 micrometers acid or alkaline zinc is used and, as from 12 micrometers alkaline zinc is used.

An aqueous intermediate layer is fixed over the base layer containing silicon oxide nanoparticles of up to 50 nanometers further comprising the following compounds in percentage by weight:
from 15% to 32% colloidal silica;
from 2.4% to 8%2-Butoxyethanol;
from 0% to 10% Methanol;
from 50% to 70% Water;
from 0% to 6% Tetraethoxysilane;
from 0% to 2% polyvinyl alcohol;

In a preferred embodiment of the invention the intermediate layer comprises the following compounds in percentage by weight:
32% colloidal silica
8%2-Butoxyethanol;
10% Methanol;
50% Water.

Over the intermediate layer there is further fixed an outer layer comprising aluminum dispersed in organic solvents or water and binding elements.

The outer layer comprises the following composition in percentage by weight:
from 40 to 50% propylene glycol monomethyl ether acetate;
from 3 to 10% aluminum;
from 3 to 5% n-butyl alcohol;
from 1 to 3% bisphenol A;
from 1 to 3% heavy hydrogen desulfurized naphta;
from 1 to 3% naphta, petroleum, light aromatic solvent 1.
from 0 to 1% formaldehyde;
from 0 to 0.2%2-methoxy-1-propanol acetate;
from 0 to 0.2% naphtalene <0.2.

It is emphasized that each one of the layers can be applied one or more times to the metallic substrate.

The process of applying the coating disclosed herein on a metallic component, is configured by the following steps:
a) the base layer is applied over the surface of the metallic component;
b) the intermediate layer is applied after the curing of the base layer, whereby the intermediate layer is applied in liquid state by soaking and centrifuging, spray or soaking and draining, passing through curing in furnace with temperature between 170 and 200° C. for 25 to 240 minutes; and
c) the outer layer is applied after the cure of the intermediate layer.

In a preferred embodiment of the invention, the application of the outer layer is carried out by soaking and centrifuging, spray or soaking and draining, whereby from 1 to 3 layers of said outer layer can be applied, whereby each outer layer must be cured in oven with temperature between 180 and 230° C. for 15 to 30 minutes.

The base layer can be organometallic in liquid state applied over the metallic surface of the component by means of the following steps:
a) cleaning of the surface of the component by degrease with aqueous alkaline solution, and, next, abrasive cleaning, using blasting with steel microspheres;
b) the base layer is applied by spray to the surface of the components using a manual or automatic spray pistol, whereby the components are arranged on supports or hung in hangers or jigs or the components are arranged in a basket of a centrifuge, whereby the base layer is applied by soaking in a full container with the base layer and, after soaking, the basket initiates the centrifuging so as to remove the excess of base coating, or the components are dipped into the base layer and removed so that the set drains the excess base layer, whereby these alternatives of layer provide a liquid and uniform layer over the surface of the component;
c) the coated components are then cured in a furnace at a temperature from 200 to 340° C. for 15 to 30 minutes (depending on the technology applied, solvent base or aqueous base).

The base layer can be electrolytic zinc or zinc alloys, whereby there may further be used alkaline zinc plating process without cyanide, rotating and still bath and/or acid zinc plating and/or zinc/iron plating and/or nickel zinc plating.

The present invention further teaches a use for the coating disclosed herein in fasteners which are in direct contact with aluminum components.

### BRIEF DESCRIPTION OF THE FIGURES

FIG. 1 shows an electrical insulation between the fasteners and the aluminum structure by means of screws with insulating washers (EPDM).

FIG. 2 shows the use of the insulating covers.

FIG. 3 shows the coating (5) of this invention, with the illustration of a base metal (1), a base layer (2) configured by electrolytic zinc or organometallic, an intermediate layer (3) comprised of a nanoceramic sealant and, finally, an outer layer (4) rich in aluminum.

FIG. 4 shows a conventional electrolytic zinc surface.

FIG. 5 shows an electrolytic zinc surface with the nanoceramic sealant of the present invention.

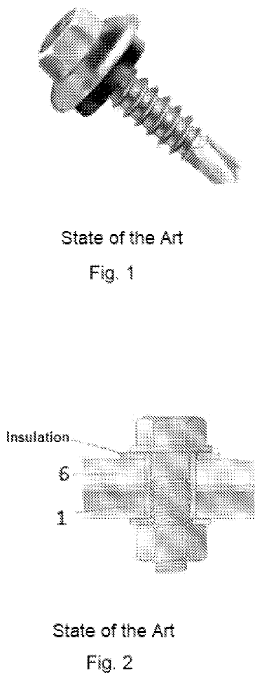

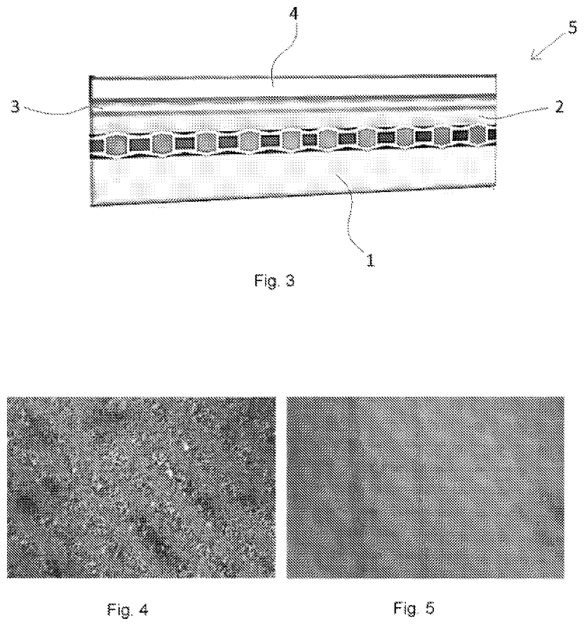

### DETAILED DESCRIPTION OF THE INVENTION

The present invention discloses the composition of a multilayer coating (5) and respective process of applying same to metallic substrates, such as steel and iron. Said coating (5) comprises an aluminum load on its upper layer (4), which is in direct contact with an aluminum counterpart (not illustrated), minimizing or eliminating the galvanic cell effect, since there is direct contact of the aluminum of the upper layer (4) with the aluminum of the counterpart (not illustrated).

Thus, the present invention differs from the traditionally coated carbon steel fasteners, which maintain direct contact of the zinc of the coating with the aluminum of the counterpart, not eliminating or minimizing the galvanic cell effect and, therefore, having a poor cost-benefit ratio.

The multilayer coating (5) consists of three distinct types of layers, which provides a resistance to natural corrosion and weather much greater than the traditional coatings, due to the use of at least one intermediate layer (3) of a nanotechnology sealant (more than 5.000 h resistance to the neutral salt spray test in accordance with ASTM B-177 rule, against up to 1.500 h of the conventional coatings).

FIG. 4 shows the surface of the conventional electrolytic zinc and FIG. 5 shows the surface of the electrolytic zinc with nanoceramic sealant.

In this way, the present invention discloses a coating composition (5) and the respective process of applying said coating (5) to metallic fasteners, maintaining the use of zinc as base of the coating against corrosion.

Thus, to solve the problems of the state of the art described herein, the coating (5) of the present invention presents a nanotechnology coating layer to enhance resistance to corrosion.

Additionally, there is added over the nanotechnology coating one or more layers of a coating rich in aluminum to significantly reduce the galvanic corrosion effect in steel, iron or other metal alloys components, when these components are placed in direct contact with aluminum substrates.

Thus, the present invention discloses a coating composition (5) comprised of at least three types of distinct layers applied to the same metallic component for protection against corrosion and reduction of the galvanic corrosion (galvanic cell effect.

The coating (5) of the present invention is comprised of a base layer (2) configured by an organometallic dispersion (zinc flakes) based on zinc and aluminum alloys in an aqueous base or of organic solvents, containing binding elements, organic solvents or water, alcohols, and ethers; or even a zinc base or zinc alloys electrolytically applied to a metallic surface.

The intermediate layer (3) is a nanoceramic coating, more specifically an aqueous coating containing silicon oxide nanoparticles of up to 50 nanometers dispersed in water, binding elements, alcohols and ethers.

In summary, the coating is applied as an intermediate layer (3), having the function of significantly increasing resistance against corrosion.

The intermediate layer (3) is a liquid, free of heavy metals, applied in a similar manner as the organometallic coatings, by soaking and centrifuging, spray or soaking and draining, passing through cure in furnace between 170° C. and 200° C. for at least 25 minutes and at the most 240 minutes.

The nanoceramic coating, that is, the intermediate layer (3) comprises the following components by weight:
Colloidal Silica 15% to 32%;
2-Butoxyethanol 2.4% to 8%;
Methanol 0% to 10%;
Water 50% to 70%;
Tetraethoxysilane 0% to 6%;
Poly vynil alcohol 0% to 2%.

Preferably, the intermediate layer (3) comprises the following components in the following proportions by weight:
Colloidal Silica 32%;
2-Butoxyethanol 8%;
Methanol 10%;
Water 50%.

The intermediate layer (3) promotes the coating of the surface of the base layer (2), preventing or avoiding the contact of the base layer (2) with the atmosphere and, in this manner, increasing the lifespan of the coated metallic component.

The outer layer (4) is rich in aluminum dispersed in organic solvents or water and binding elements, being a silver-colored viscous liquid, which comprises the following compounds in percentage by weight:
from 40 to 50% propylene glycol monomethyl ether acetate;
from 3 to 10% aluminum;
from 3 to 5% n-butyl alcohol;
from 1 to 3% bisphenol A;
from 1 to 3% heavy hydrogen desulfurized naphta (mineral oil);
from 1 to 3% naphta, petroleum, light aromatic solvent 1.

The outer layer (4) can further comprise the following compounds in percentage by weight:
from 0 to 1% formaldehyde;
from 0 to 0.2%2-methoxy-1-propanol acetate;
from 0 to 0.2% naphtalene <0.2.

The application of the outer layer (4) is preferably carried out by soaking and centrifuging, spray or soaking and draining, whereby there can be applied from 1 to 3 layers, whereby each layer must be cured in furnace between 180 and 230° C., for 15 to 30 minutes.

Thus, the coating (5) comprises at least the three distinct types of layers: the base layer (2), the intermediate layer 3) and the outer layer (4), which grant the metal components with high resistance against corrosion and eliminate or reduce considerably the galvanic corrosion effect when metallic components comprised of said coating (5) are assembled or placed in direct contact with aluminum substrates and the alloys thereof, coated or not.

In one embodiment of the invention, the base coating layer (2) is of electrolytic zinc.

For the purposes of the definition of the application of the base coating layer (2), the cathode is the element wherein there occurs the reduction, metal deposition-object which will be coated, and the anode is the electrode on which there occurs the oxidizing, whereby this can be soluble—in this case the anode metal goes to the solution—or insoluble.

The electrolytes are thus called all the solutions that carry electric power. The ions are thus called the charged particles which move in the solution.

Galvanizing is the process of coating one metal with another, so as to protect same against corrosion or improve the appearance thereof. Thus, galvanizing is a surface coating process by means of electrolysis wherein the metal to be coated acts as a cathode and the metal that will coat the part acts as the anode, whereby there may also be used as anode an inert material.

The electrolytic solution must contain a salt comprised of cations of the metal which it is desired to coat the component.

As a rule, different metals can be used for coating a component. The process of coating with zinc is called zinc plating. Zinc plating is a surface treatment which provides great resistance to corrosion, whereby the protective layer is uniform and adherent.

The zinc plating time determines the thickness of the deposited layer. In the present invention, the thickness of the electrolytic zinc layer or zinc alloys is between 5 and 25 micrometers, whereby there can be used the following zinc plating variants:
Cyanide-free alkaline zinc plating, rotating and still bath;
Acid zinc plating;
Zinc/Iron zinc plating;
Zinc Nickel zinc plating.

In the present invention there can be used electrolytic zinc or alloy zinc of 5 to 25 micrometers, whereby up to 12 micrometers acid zinc is used and as from 12 micrometers alkaline zinc is used.

### Acid Zinc Plating

Zinc plating processes from an acid solution were developed more than 200 years ago. The first processes were based on zinc sulfate. This type of process is still used today for applications wherein it is necessary to operate at high current densities, such as, for example, continuous lines of sheets or wires. In zinc processes which operate in rotating drum or plate hooks, the suitable acid processes are those which use chloride-based solutions.

The concentrations and operating conditions with three processes are described in table 1.

TABLE 1
ACID-BASE ZINC PROCESS

| | Ammonia | Potassium | Mixed |
|---|---|---|---|
| Metal zinc | 10 to 50 g/L | 20 to 50 g/L | 10 to 50 g/L |
| Ammonium | 110 to 180 g/L | 0 | 30 to 60 g/L |
| chloride | | | |
| Potassium chloride | 0 | 180 to 360 g/L | 120 to 180 g/L |
| Boric acid | 0 | 22 to 40 g/L | 0 |
| pH | 5 to 6 | 4.5 to 5.5 | 5 to 6 |
| Temperature (° C.) | 10 to 40 | 18 to 45 | 10 to 50 |

Next there are described the considerations about the operating parameters for metal zinc and chloride.

The zinc is replaced in the bath by means of the use of high purity zinc anode in balls, bars, or ingots. Since the process has good anodic corrosion efficiency, it is very easy to maintain the zinc concentration in the bath with good control of the anodic area.

The anodes in bars are hung on the anodic bar with titanium hooks, however, the use of anodic baskets constructed in titanium is much more common.

The chloride is responsible for the conductivity of the solution and the anodic corrosion. High concentrations of chloride reduce the turbidity point of the solution. Higher chloride concentration, higher tendency to burn at high density of current, greater anode dissolution.

During electrolysis there exists a hydrogen evolution, according to the previously shown reaction. In this way, the pH becomes higher and must be corrected with chloride acid.

Ammonium chloride, in addition to other functions, also serves as a pH buffer. When ammonia is not used it is necessary to use boric acid for this function. For the complete elimination of the ammonium chloride, it was necessary to develop new additive systems to achieve the same results obtained with the ammonia.

The additives were comprised of organic non-water-soluble products which required solvents to remain soluble in the bath. These components had low tolerance to temperature, with turbidity points of the solution below 50° C., initiating decomposition at temperatures of 30° C., causing stains and cloudiness in the deposit, apart from raising the organic contamination of the bath.

### Alkaline Zinc Plating

Cyanide-free alkaline electrolytic zinc plating is an ecologically correct process (completely free from cyanides) which significantly reduces the amount of polluting effluents generated. This process is indicated for iron, steel or zamak materials.

The use of this process provides the following advantages: excellent penetration, uniformity of layer, absence of white corrosion in welding areas, clear and bright deposits; can be applied in still bath process (larger components) or rotating automatic (smaller items).

After applying the zinc, the process is finalized with passivation, which must be chosen according to the application characteristics of the items. For items with high resistance there further exists the indication for the application of sealants.

TABLE 2
ALKALINE-BASE ZINC PROCESS

| | Preferred range | Range |
|---|---|---|
| Metal Zinc | 10 to 12 g/L | 8 to 17 g/L |
| Zinc oxide (purity >99.8%) | 12.5 to 15 g/L | 10 to 21 g/L |
| Caustic soda | 130 to 140 g/L | 110 to 140 g/L |
| Sodium carbonate | 50 g/L | <80 g/L |
| Temperature | 26 to 30° C. | 22 to 40° C. |

| | |
|---|---|
| Cathode Current Density | 0.5 to 6 A/dm² |
| Cathode Efficiency | 50 to 75% |
| Layer Deposited | 0.2 micrometer/minute using 1 A/dm² |
| Agitation (recommended) | Cathode 3 to 5 m/minute |

In one embodiment of the invention, the base coating layer (2) is organometallic (zinc flakes). Non-electrolytic organometallic coatings are constituted of lamelar zinc, which provide good protection against corrosion. These coatings comprise a mixture of zinc and aluminum, which are connected to each other by an inorganic matrix.

The specifications for the organometallic coatings are defined in the international ISO 10683 norms and also in European norm DIN EN 13858.

DIN EN ISO 10683 defines the requirements for organometallic coatings for threaded elements and DIN EN 13858 describes the requirements for zinc flake coatings for elements without thread and for other parts as well.

There are three groups of organometallic coatings:
Containing Cr (VI) (hexavalent chrome): surface treatments containing Cr (VI) provide greater protection against corrosion with a thinner layer, but the Cr (VI) is carcinogenic and constitutes a potential risk to the environment. New European decrees prohibit the use of surface treatments containing Cr (VI). These include end-of-life vehicles and electric and electronic equipments. For application outside the automobile and electric industries these coatings are still valid;
Cr (VI) free-Solvent free hexavalent chrome based coatings;
Cr (VI) free-water-based hexavalent chrome free coatings;
Cr (VI) free coatings are more environment-friendly than the surface treatments that contain Cr (VI). No organometallic coating used in the automobile industry nowadays contains this substance.

In a preferred embodiment of the invention, the organometallic coating composition (zinc flakes), based on organic solvent comprises the following composition in percentage by weight:
from 20 to 60% zinc;
from 1 to 5% aluminum—from 10 to 20% de 2-Ethylhexanol;
from 5 to 10% heavy hydrogen desulfurized naphta (mineral oil);
from 0 to 3% n-butyl alcohol 71-36-3 1;
from 1 to 3% naphta solvent, petroleum, light aromatic;
from 1 to 3% stearic acid;
from 0 to 0.2% ethylbenzene;
from 0 to 0.2% standard solvent.

In another preferred embodiment of the invention, the aqueous based organometallic coating composition (zinc flakes) is configured by the mixture of compounds A, B and C which comprise the following composition in percentage by weight:

### Compound A

from 20 to 40% zinc;
from 2 to 10% aluminum
20 30% propyleneglycol
1 to 2.5% non-ionic surfactant
15 to 20% deionized water

### Compound B

Silane (A-187)
70 to 90% deionized water
0.1 to 0.2% boric acid
2 to 3% sodium silicate

### Compound C

0.2 to 2% hydroxiethylcellulose per Kg of the mixture of compounds A+B

Several manufacturers, such as automobile companies and the suppliers thereof, produced their own specifications and supply rules, so as to define the requirements for these coating systems.

Organometallic coating (zinc flakes) is a generic expression for the coating technology.

Organometallic coatings are provided in liquid form and can be applied using the following application techniques:
Prior to coating, the surface of the components must be pre-treated. In this process chemical pickling with acids is not used (for example, sulfuric acid or hydrochloric acid) which can produce atomic hydrogen and penetrate the steel structure and make it fragile. In order to avoid pickling processes, other pre-treatment processes are necessary. The typical cleaning processes are degrease with an aqueous alkaline solution and, next, abrasive cleaning, using blasting with steel microspheres.
The degrease removes wax, oil and dirt from the metal surface;
the blasting removes surface oxidation by means of the mechanical action of the steel microspheres, which are fired against the components inside a chamber using a turbine. None of the pre-treatment processes produces any hydrogen, therefore there is no danger of hydrogen embrittlement in high strength steel.

Following the pre-treatment, next there is carried out the coating process:
Spray: The coating is applied to the surface of the components using a spray gun. This can be done manually or in a fully automated spraying installation (this process is used for larger or heavier components). The components are accommodated in supports or hung in hangers or jigs.
Dip-spin (soaking and centrifuging): The components are placed in the basket of a centrifuge. The coating is applied by immersion in a container full of the coating and after immersion, the basket begins centrifuging so as to remove the excess coating material (this process is used for high volume smaller components, also called batch process).
soaking-draining: Dipping the components into the coating material and pulling outwards so that the set drains the excess coating, for example, in tubes. However, the components must have sufficient openings for the material to drain, otherwise the coating can present faults, such as coating accumulation and air bubbles.

The coating forms a liquid, uniform layer over the surface of the components. In order to develop the excellent coating properties of the zinc flakes, a cure process is required.

The coated components are cured in a furnace at a controlled temperature during a determined period. The typical cure temperatures are 200 to 340° C., since they depend on the technology applied, solvent base or aqueous base. After the cure, a uniform, fine and adherent film is produced.

Organometallic coatings form what is known as cathode protection: the noble metal (zinc) sacrifices itself to protect the base metal (steel). In this way, the steel can be protected.

The average coating thickness is between 5 μm and 12 micra, whereby it is possible to apply thicker layers.

The description made up to now of the present invention must be considered solely as one or more possible embodiments, and any particular characteristics introduced therein must be understood only as something that was described to facilitate understanding. In this way, they must not be considered as limitations of the invention, which is limited to the scope of the claims.

The examples which will be presented illustrate the scope of the invention proposed herein.

### Examples

The coating (5) with an organometallic base layer (2) was applied to fasteners, more specifically screws, whereby the screw was in direct contact with aluminum substrate for 2.500 h of neutral salt spray test (salt spray ASTM B-117) without presenting red corrosion (red corrosion=iron/steel substrate corrosion).

The coating (5) with an electrolytic zinc base layer (2) was applied to fasteners, more specifically screws, whereby the screw was in direct contact with aluminum substrate for 2.500 h of neutral salt spray test (salt spray ASTM B-117) without presenting red corrosion (red corrosion=iron/steel substrate corrosion).

Carbon steel fasteners coated with electrolytic zinc and zinc alloys have resistance to corrosion between 24 h and 720 h (without forming galvanic cell). Carbon steel fasteners coated with organometallics have an average resistance of 1000 h (without forming galvanic cell).

The coating layer (5) has a range of 8 to 20 micron, whereby it may be applied to several components, such as screws, stampings, clips, washers, nuts, etc.

In one embodiment, the present invention replaces fasteners and components manufactured in stainless steel with considerable cost reduction and good resistance to galvanic cell.

1. Coating composition, wherein said coating (5) is configured by at least one base layer (2), one intermediate layer (3) and an outer layer (4), applied to the same metallic component, wherein the base layer (2) comprises:
an organometallic dispersion based on zinc and aluminum alloys or
a zinc or zinc alloy base applied electrolytically to the metallic surface (1)
characterized by the intermediate aqueous layer (3) comprise silicon oxide nanoparticles of up to 50 nanometers and further comprise the following compounds in percentage by weight:
from 15% to 32% colloidal silica;
from 2.4% to 8%2-Butoxyethanol;
from 0% to 10% Methanol;
from 50% to 70% Water;
from 0% to 6% Tetraethoxysilane;
from 0% to 2% polyvinyl alcohol;
the external layer (4) comprises the following compounds in percentage by weight:
from 40 to 50% propylene glycol monomethyl ether acetate;
from 3 to 10% aluminum;
from 3 to 5% n-butyl alcohol;
from 1 to 3% bisphenol A;
from 1 to 3% heavy hydrogen desulfurized naphta;
from 1 to 3% naphta solvent, petroleum, light aromatic 1,
from 0 to 1% formaldehyde;
from 0 to 0.2%2-methoxy-1-propanol acetate;
from 0 to 0.2% naphtalene <0.2.

2. Coating composition according to claim 1, characterized by the intermediate layer (3) comprise the following compounds in percentage by weight:
32% colloidal silica;
8%2-Butoxyethanol;
10% Methanol;
50% Water.

3. Coating composition according to claim 1, characterized by the base layer (2) being an organometallic coating which comprises the following composition in percentage by weight:
from 20 to 60% zinc;
from 1 to 5% aluminum
from 10 to 20%2-Ethylhexanol;
from 5 to 10% heavy hydrogen desulfurized naphta (mineral oil);
from 0 to 3%71-36-3 1 rs-butyl alcohol;
from 1 to 3% naphta solvent, petroleum, light aromatic;
from 1 to 3% stearic acid;
from 0 to 0.2% ethylbenzene;
from 0 to 0.2% standard solvent.

4. Coating composition according to claim 1, characterized by the base layer (2) being an organometallic aqueous base coating configured by the mixture of a compound A, a compound B and a compound C, wherein the compounds comprise the following composition in percentage by weight:
Compound A
from 20 to 40% zinc;
from 2 to 10% aluminum
20 30% propyleneglycol
1 to 2.5% non-ionic surfactant
15 to 20% deionized water
Compound B
Silane (A-187)
70 to 90% deionized water
0.1 to 0.2% boric acid
2 to 3% sodium silicate
Compound C
0.2 to 2% hydroxiethylcellulose per Kg of the mixture of compounds A+B

5. Process of applying a coating to a metallic component using the composition of claim 1, characterized by comprise the following steps:
a) Base layer (2) being applied to the surface (1) of a metallic component;
b) the intermediate layer is applied after the curing of the base layer, whereby the intermediate layer is applied in liquid state by soaking and centrifuging, spray or soaking and draining, passing through curing in furnace with temperature between 170 and 200° C. for 25 to 240 minutes;
c) outer layer (4) being applied after the cure of the intermediate layer (3).

6. Process of applying a coating, according to claim 5, characterized by each one of the layers (2, 3, 4) being applied one or more times on the surface (1) of a metallic component.

7. Process of applying a coating (5) to a metallic component, according to claim 5, characterized by the application of the outer coating (4) being carried out by soaking and centrifuging, spray or soaking and draining, so as to apply from 1 to 3 layers of said outer layer (4), whereby each layer must be cured in furnace at a temperature between 180 and 230° C. for 15 to 30 minutes.

8. Process of applying a coating (5) to a metallic component, according to claim 5, characterized by the base coating (2) being organometallic in liquid state applied on the metallic surface (1) of the component by means of the following steps:
a) cleaning of the surface of the component by degrease with aqueous alkaline solution, and, next, abrasive cleaning, using blasting with steel microspheres;
b) the base layer (2) is applied by spray to the surface of the components using a manual or automatic spray pistol, whereby the components are arranged on supports or hung on hangers or jigs, or the components are arranged in a basket of a centrifuge, whereby the base layer (2) is applied by soaking in a full container with the base layer (2) and, after soaking, the basket initiates the centrifuging so as to remove the excess of base coating (2), or the components are dipped into the base coating (2) then removed so that the set drains the excess base coating (2), whereby these coating alternatives provide a liquid and uniform layer of the base coating (2) on the surface of the component;
c) the coated components are then cured in a furnace at a temperature from 200 to 340° C. for 15 to 30 minutes.

9. Process of applying a coating (5) to a metallic component, according to claim 5, characterized by the base coating (2) being electrolytic zinc or alloy zinc, whereby the cyanide-free alkaline zinc plating process can be used, rotating and still bath or acid zinc plating or zinc/iron plating and or nickel/iron zinc plating.

10. Process of applying a coating (5) to a metallic component, according to claim 9, characterized by being applied a base coating (2) with a thickness of 5 to 25 micrometers, whereby up to 12 micrometers the zinc deposition process is carried out by means of an acid solution and as from 12 micrometers the zinc deposition process is carried out by means of alkaline solution.

11. Process of applying a coating (5) to a metallic component, according to claim 5, characterized by the surface (1) being a fastener that is in direct contact with the aluminum components.
